(19) United States
(12) Patent Application Publication
(10) Pub. No.: US 2020/0217281 A1
(43) Pub. Date: Jul. 9, 2020

(54) SYSTEM AND METHOD FOR ON-BOARD ELECTROCHEMICAL UPGRADING OF HYDROCARBON FUELS

(71) Applicant: Saudi Arabian Oil Company, Dhahran (SA)

(72) Inventor: Wajdi I. Al Sadat, Dhahran (SA)

(73) Assignee: Saudi Arabian Oil Company, Dhahran (SA)

(21) Appl. No.: 16/241,371

(22) Filed: Jan. 7, 2019

(51) Int. Cl. F02M 27/04; B60K 15/03; F02M 27/02; B60K 15/07; F02M 21/02

(52) U.S. Cl. CPC F02M 27/04; B60K 15/03006; F02M 27/02; B60K 2015/03019; F02M 21/0224; F02M 21/029; B60K 15/07

(57) ABSTRACT

Vehicles, systems, and methods for the on-board, electrochemical upgrading of hydrocarbon fuels are provided. In one embodiment, a vehicle is provided where the reformed fuel subsystem comprises an electrochemical cell, a hydrocarbon fuel inlet, an oxidizing gas inlet, an unreacted gas outlet, and a reformed hydrocarbon fuel outlet. The hydrocarbon fuel inlet is configured to direct at least a portion of hydrocarbon fuel originating from the on-board point-of-sale fuel tank to the electrolyte of the electrochemical cell. The oxidizing gas inlet is configured to direct an oxidizing gas to the positive electrode of the electrochemical cell. The positive electrode of the electrochemical cell is configured to form a reduced mediator species from the oxidizing gas. The electrochemical cell is structurally configured to contact the reduced mediator species and hydrocarbon fuel from the hydrocarbon fuel inlet with the electrolyte of the electrochemical cell to upgrade a native octane rating of the hydrocarbon fuel.

### BACKGROUND

The present disclosure relates to systems and methods for upgrading hydrocarbon fuels, and more particularly to vehicles and vehicular systems for on-board electrochemical upgrading of hydrocarbon fuels.

### BRIEF SUMMARY

According to the subject matter of the present disclosure, vehicles, systems, and methods for the on-board, electrochemical upgrading of hydrocarbon fuels are provided.

According to one embodiment of the present disclosure, a vehicle is provided comprising an on-board point-of-sale fuel tank, an operator accessible point-of-sale fuel filling port, an internal combustion engine that is configured to provide motive force to the vehicle, and a reformed fuel subsystem. The reformed fuel subsystem comprises an electrochemical cell, a hydrocarbon fuel inlet, an oxidizing gas inlet, an unreacted gas outlet, and a reformed hydrocarbon fuel outlet. The electrochemical cell is capable of producing electrical energy. The hydrocarbon fuel inlet is configured to direct at least a portion of hydrocarbon fuel originating from the on-board point-of-sale fuel tank to the electrolyte of the electrochemical cell. The oxidizing gas inlet is configured to direct an oxidizing gas to the positive electrode of the electrochemical cell. The positive electrode of the electrochemical cell is configured to form a reduced mediator species from the oxidizing gas. The unreacted gas outlet is configured to direct at least a portion of an unreacted gas from the electrochemical cell towards the atmosphere. The reformed hydrocarbon fuel outlet is configured to direct reformed hydrocarbon fuel towards the internal combustion engine. The electrochemical cell comprises a positive electrode, a negative electrode, and an electrolyte disposed between the positive electrode and the negative electrode. The electrochemical cell may be structurally configured to contact the reduced mediator species from the positive electrode and hydrocarbon fuel from the hydrocarbon fuel inlet with the electrolyte of the electrochemical cell to upgrade a native octane rating of the hydrocarbon fuel. The reformed fuel subsystem may be structurally configured to deliver the upgraded hydrocarbon fuel to a combustion zone of the internal combustion engine.

In accordance with another embodiment of the present disclosure, a method of upgrading a hydrocarbon fuel and operating a power producing electrochemical cell may comprise passing hydrocarbon fuel through the operator accessible point-of-sale fuel filling port into the on-board point-of-sale fuel tank, passing the hydrocarbon fuel from the on-board point-of-sale fuel tank to the electrolyte of the electrochemical cell, passing the oxidizing gas to the electrochemical cell through the oxidizing gas inlet. The method may further comprise upgrading the native octane rating of the hydrocarbon fuel in the electrochemical cell and generating the upgraded hydrocarbon fuel, generating electrical energy in the electrochemical cell, passing the upgraded hydrocarbon fuel from the electrochemical cell to the combustion zone of the internal combustion engine, combusting the upgraded hydrocarbon fuel in the internal combustion engine, and utilizing the energy generated in the internal combustion engine to move the vehicle.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1 presents a schematic diagram of the system for electrochemical upgrading of hydrocarbon fuels and power generation, according to one of the embodiments presently disclosed; and

FIG. 2 presents a schematic diagram of the system for electrochemical upgrading of hydrocarbon fuels and power generation, according to one of the embodiments presently disclosed.

### DETAILED DESCRIPTION

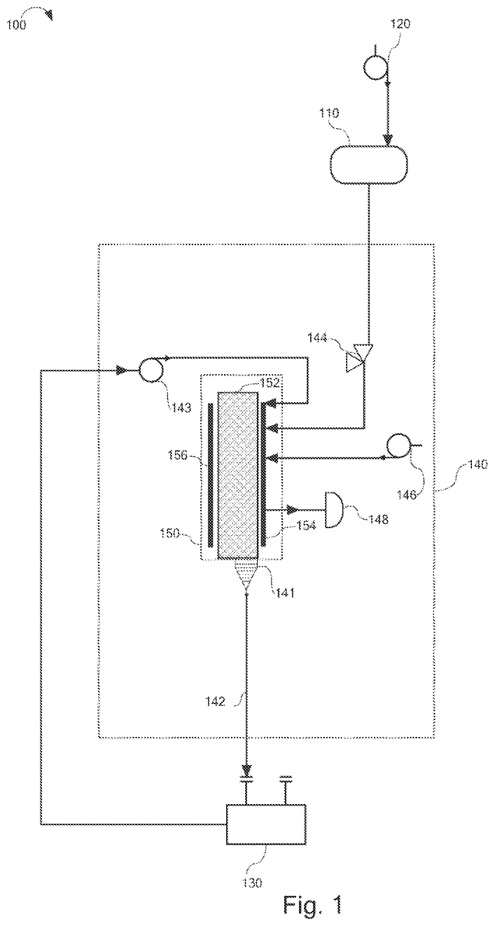

Referring initially to FIG. 1, and according to one or more embodiments of the present disclosure, a vehicle 100 is provided comprising an on-board point-of-sale fuel tank 110, an operator accessible point-of-sale fuel filling port 120, an internal combustion engine 130 that is configured to provide motive force to the vehicle 100, and a reformed fuel subsystem 140. It should be understood that the on-board point-of-sale fuel tank 110 refers to a fuel tank that is integrated with, attached to, or is otherwise configured to move with, the vehicle 100, and which may be filled with a purchased fuel.

The operator accessible point-of-sale fuel filling port 120 can be any conventional or yet to be developed fuel filling port that is structurally configured to transfer hydrocarbon fuel from a point-of-sale fuel dispenser to the on-board point-of-sale fuel tank 110. The reformed fuel subsystem 140, which is described in further detail below, is structurally configured to reform hydrocarbon fuel from the on-board point-of-sale fuel tank 110 and transfer reformed fuel to the internal combustion engine 130 along a reformed fuel supply pathway 142.

The reformed fuel subsystem 140 illustrated in FIG. 1 comprises an electrochemical cell 150, a hydrocarbon fuel inlet 144, an oxidizing gas inlet 146, an unreacted gas outlet 148, and a reformed hydrocarbon fuel outlet 141. The electrochemical cell 150 is capable of producing electrical energy. The hydrocarbon fuel inlet 144 is configured to direct at least a portion of hydrocarbon fuel originating from the on-board point-of-sale fuel tank 110 to the electrolyte 152 of the electrochemical cell 150. The oxidizing gas inlet 146 is configured to direct an oxidizing gas to the positive electrode 156 of the electrochemical cell 150. The positive electrode 154 of the electrochemical cell 150 may be configured to form a reduced mediator species from the oxidizing gas. The unreacted gas outlet 148 may be configured to direct at least a portion of an unreacted gas from the electrochemical cell 150 towards the atmosphere. The reformed hydrocarbon fuel outlet 141 is configured to direct reformed hydrocarbon fuel towards the internal combustion engine 130. According to some embodiments, the reformed fuel subsystem 140 may further comprise a carbon dioxide inlet 143 configured to direct a gas comprising carbon dioxide to the electrolyte 152 of the electrochemical cell 150.

Without being limited by theory, it is believed that the positive electrode 154 may convert the oxidizing gas into a reduced mediator species. Specifically, it is believed that the reduced mediator species includes the superoxide radical O₂⁻. The reduced mediator species, acting as a reducing agent or nucleophile, may react with a hydrocarbon fuel from the hydrocarbon fuel inlet 144 to upgrade a native octane rating of the hydrocarbon fuel.

The electrochemical cell 150 comprises a positive electrode 154, a negative electrode 156, and an electrolyte 152 disposed between the positive electrode 154 and the negative electrode 156. The electrochemical cell 150 may be structurally configured to contact the reduced mediator species from the positive electrode 154 and hydrocarbon fuel from the hydrocarbon fuel inlet 144 to upgrade a native octane rating of the hydrocarbon fuel.

The reformed fuel subsystem 140 may be structurally configured to deliver the upgraded hydrocarbon fuel to a combustion zone of the internal combustion engine 130. The electrochemical cell 150 may be structurally configured to contact the reduced mediator species from the positive electrode 154, hydrocarbon fuel from the hydrocarbon fuel inlet 144, and carbon dioxide gas from the carbon dioxide inlet 143 with the electrolyte 152 of the electrochemical cell to upgrade a native octane rating of the hydrocarbon fuel.

The negative electrode 156 may be selected such that when paired with oxygen, the Gibbs free energy of reaction will be negative and the negative electrode 156 will be the anode. The Gibbs free energy of a reaction defines the maximum reversible work which may be performed by a system. When the Gibbs free energy of a reaction is negative, the reaction will proceed spontaneously.

The reformed fuel subsystem 140 may further comprise a carbon dioxide inlet 143. The carbon dioxide inlet 143 may be structurally configured to introduce a gas comprising carbon dioxide into the electrolyte 152.

The carbon dioxide inlet 143 may be structurally configured to receive a carbon dioxide containing exhaust gas from the internal combustion engine 130. Exhaust gasses may contain chemicals capable of degrading the electrochemical cell, such as water vapor, sulfates, and particulates. Some of the potential ionic liquid electrolytes useful for this disclosure may be hygroscopic and degrade in the presence of water. As such, the carbon dioxide inlet 143 may comprise a device for removing water, water vapor, or both. The carbon dioxide inlet 143 may also comprise processing equipment to remove undesirable chemicals such as, but without limitation, sulfates, particulates, and carbon monoxide.

Hydrocarbon liquids from the hydrocarbon fuel inlet 144 may form a heterogeneous liquid hydrocarbon layer atop the electrolyte 152. Without being limited by theory, it is believed that the heterogeneous liquid hydrocarbon layer may serve to protect the electrolyte 152 from the intrusion of water and water vapor by forming a water impermeable barrier layer. Gasses from the carbon dioxide inlet 143 and the oxidizing gas inlet 146 may enter the heterogeneous liquid hydrocarbon layer by diffusion, or by a convection device. The gasses may then enter the electrolyte 152 by diffusion from the heterogeneous liquid hydrocarbon layer to the electrolyte 152. Gas exchange between the liquid hydrocarbon layer and the electrolyte 152 may be a pure diffusion process or rely on a convection device. For example, a convection device may include a roughened flow field or a sparger.

The carbon dioxide inlet 143 may further comprise carbon dioxide concentrating equipment, such as, membrane separators or pressure swing adsorption concentration devices. Increasing concentrations of carbon dioxide may help to minimize the required size of the electrochemical cell. Increased carbon dioxide concentrations in the electrolyte 152 may further cause increased carboxylation rates in the hydrocarbon fuel.

The composition of the electrolyte 152 may be selected to complex with carbon dioxide from the carbon dioxide inlet 143 and form a carbon dioxide-electrolyte complex, oxalate, ester, formate, or carbonate. The carbon dioxide-electrolyte complex may be capable of being formed under any conditions, although it is believed that the complex will form faster in the presence of superoxides produced at the positive electrode 154.

The electrochemical cell 150 may be configured as one or more of a coin cell, a pouch cell, a flow cell, a hybrid cell, a flooded cell, or a flow cell. As used in this disclosure, a hybrid cell shares attributes of a static battery and a flow cell. For example, in a hybrid cell, a static metal negative electrode 156 may be used with a flowing electrolyte, which flows through the positive electrode 154.

The electrochemical cell 150 may be configured as a primary battery. By definition, primary batteries are not electrically rechargeable. The electrochemical cell 150 may be capable of mechanical recharge, mechanical recharge may be defined as replacing the electrolyte 152 and the metal negative electrode 156 with fresh materials. A system configured with a primary battery and mechanical recharge may have the advantage of improved battery durability, decreased formation of dendrites, and extremely rapid recharge. The configuration of a primary battery with mechanical recharge also reduces challenges associated with the design of a reversible oxygen electrode.

The electrochemical cell 150 may also be configured as a secondary battery. By definition, secondary batteries are capable of electrical recharge. A cell capable of electrical recharge has the advantage of simplicity and ubiquitous charging locations. Some configurations of the electrochemical cell 150 comprise a combination of characteristics associated with primary and secondary batteries. For example the electrochemical cell may be capable of electrical recharge but be capable of, or even require, replenishment of the electrolyte 152 or the electrodes or both, after a period of time.

The negative electrode 156 may comprise a metal material. The metal material may comprise lithium, sodium, potassium, magnesium, aluminum, zinc, calcium, copper, silicon, iron, or a combination thereof. The negative electrode 156 may be structured as metal plates, which dissolve into the electrolyte 152 as the reaction progresses. The metal plates may form oxides, metal ions, or metal complex ions in the electrolyte 152. The negative electrode 156 may also be structured as metal slurry, molten metal, intercalated metal particles, pressed metal powder, sintered metal powder, or any source of metal in a reduced state. The negative electrode 156 may be replaceable either in part or in full.

The positive electrode 154 may comprise a porous material. A porous material may be considered preferable because according to some embodiments of the present disclosure, the positive electrode 154 may be referred to as an oxygen electrode or an oxygen reduction electrode. This nomenclature stems from the reaction occurring at the positive electrode 154, the reduction of oxygen.

The positive electrode 154 may comprise stainless steel, carbon, titanium, or a combination thereof. These materials are selected for their potential porosity, conductivity, and resistance to harsh chemical, electrical, and thermal conditions. The positive electrode 154 may serve as a catalyst for the reduction of diatomic oxygen (O₂) into superoxide (O₂⁻). In the electrochemical cell 150, the positive electrode 154 may serve to transport oxygen from the oxidizing gas inlet 146 into the electrolyte 152.

The oxidizing gas inlet 146 may be structured to direct the oxidizing gas to the positive electrode 154, and the positive electrode 154 may be structured to pass at least a portion of the oxidizing gas to the electrolyte 152 disposed between the positive electrode 154 and the negative electrode 156. The positive electrode 154 may be structured to generate turbulent conditions or otherwise promote mixing of the oxidizing gas and the electrolyte 152.

The oxidizing gas inlet 146 may be structured to direct the oxidizing gas to the positive electrode 154, and the positive electrode 154 may be structured to convert at least a portion of the oxidizing gas to the reduced mediator species. The positive electrode may be structured to pass at least a portion of the reduced mediator species to the electrolyte 152 disposed between the positive electrode 154 and the negative electrode 156.

The electrolyte 152 may comprise an ionic liquid. An ionic liquid is a salt in the liquid state at a given set of conditions. In general, ionic liquids may have powerful solvating capability, superlative electrical conductivity, and be relatively safe due to extremely high vapor pressures. By way of example, but not by way of limitation, the ionic liquid may comprise imidazolium, pyridinium, ammonium, phosphonium, halides, tetrafluoroborate, hexafluorophosphate, bistriflimide, trifalate, tosylate, polymeric ionic liquids, and magnetic ionic liquids.

The ionic liquid may comprise an imidazolium. According to some embodiments, the ionic liquid comprises AlCl₃ and 1-ethyl-3-methylimidazolium chloride. The ionic liquid may comprise AlCl₃ and 1-ethyl-3-methylimidazolium chloride in a ratio of from 10:1 to 1:10. For example the ratio of AlCl₃:1-ethyl-3-methylimidazolium chloride may be from 10:1 to 9:1, 9:1 to 8:1, 8:1 to 7:1, 7:1 to 6:1, 6:1 to 5:1, 5:1 to 4:1, 4:1 to 3:1, 3:1 to 2:1, 2:1 to 1:1, 1:1 to 1:2, 1:2 to 1:3, 1:3 to 1:4, 1:4 to 1:5, 1:5 to 1:6, 1:6 to 1:7, 1:7 to 1:8, 1:8 to 1:9, 1:9 to 1:10, or any combination thereof.

The electrolyte may comprise a solvent and a salt, a homogenous catalyst, an ionic liquid, a suspended heterogeneous catalyst, or a combination thereof. A homogenous catalyst is a catalyst which dissolves in the solvent. By way of example, but not by limitation, a homogenous catalyst may be an acid, a polyoxometalate, a metal salt, a metal-organic complex, or a combination thereof. A suspended heterogeneous catalyst is a catalyst which does not dissolve but is kept in suspension by mechanical motion. By way of example, but not by limitation, a suspended heterogeneous catalyst may be metals supported on alumina, metals supported on silica, metals supported on titania, ceramics, metallic catalysts tethered to nanoparticles, zeolites, vanadium oxides, precious metals, or a combination thereof. The metals may include atoms of, for example, nickel, titanium, magnesium, molybdenum, magnesium, cobalt, iron, copper, gold, silver, platinum, ruthenium, rhodium, vanadium, sodium, potassium, lithium, calcium, scandium, chromium, manganese, zinc, aluminum, tin, germanium, indium, cadmium, zirconium, or a combination thereof.

Without being limited by theory, it is believed that in addition to the characteristics sought out in a typical electrolyte, the electrolyte may contain species which may react with the feedstocks of interest, or stabilize the superoxide species.

The electrolyte 152 may comprise one or more additives, including sodium, potassium, calcium, magnesium, aluminum, lithium, scandium, titanium, vanadium, chromium, manganese, iron, copper, cobalt, nickel, zinc, zirconium, yttrium, ruthenium, palladium, platinum, silver, gold, gallium, indium, tin, lead, silicon, fluorine, chlorine, bromine, iodine, oxalate, graphene, graphite, polymers, hydroxide, sulfuric acid, hydrochloric acid, perchloric acid, hydrofluoric acid, proteins, or enzymes. Suitable enzymes may include carboxylates, carboxyglutamate, glutamyl carboxylate, and prothrombin.

The electrochemical cell 150 may comprise a separator material disposed between the positive electrode and the negative electrode. The separator material may be a proton exchange membrane, an anion exchange membrane, or a neutral filtration membrane. The separator functions to prevent shorting of the positive and negative electrodes, prevent diffusion of reactants into undesired locations, and to prevent diffusion of reaction products into undesired locations. The separator material may comprise cation exchange membranes such as NAFION, anion exchange membranes such as FUMASEP, or neutral membranes such as asbestos based membranes.

The electrochemical cell 150 may be structurally configured to elevate a concentration of one or more of, aromatic, oxygenated, or carboxylic acid groups, in the hydrocarbon fuel. Without being limited by theory, it is believed that an increased concentration of aromatic, oxygenated, or carboxylic acid groups in the hydrocarbon fuel may lead to an increased octane rating of the hydrocarbon fuel.

The reformed fuel subsystem 140 may comprise a separation unit structurally configured to separate the upgraded hydrocarbon fuel from the electrolyte. The reformed fuel subsystem 140 may comprise a distillation unit structurally configured to separate the upgraded hydrocarbon fuel from the electrolyte. The separation unit may comprise a decanter, an absorption process, an adsorption process, a distillation process, a stripper, a bubbler, or a combination thereof. The electrolyte 152 may be circulated to the separation unit or the electrochemical cell 150 may be structured to function as a separation unit. For example, the electrochemical cell 150 may operate above the boiling point of the reformed hydrocarbon fuel but below that of the electrolyte 152, allowing the capture of the reformed hydrocarbon fuel in the vapor phase.

The electrochemical cell 150 may be configured to upgrade one or more liquid hydrocarbon fuels. Embodiments are envisioned which are configured to upgrade gasoline, diesel, biodiesel, kerosene, aviation fuel, ethanol, methanol, butanol, ammonia, jet fuel, bunker fuel, crude oil, or any liquid hydrocarbon fuel.

The electrochemical cell 150 may be configured to upgrade one or more gaseous hydrocarbon fuels. Embodiments are envisioned which are configured to upgrade natural gas, hydrogen, coal gas, syngas, biogas, acetylene, propane, butane, ethylene, carbon monoxide, or any other gaseous hydrocarbon fuel.

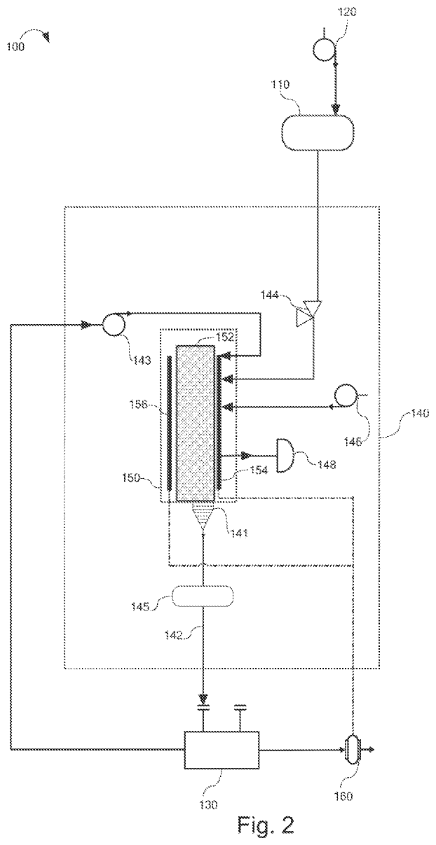

Referring now to FIG. 2, the reformed fuel subsystem 140 may comprise a reformed fuel storage tank 145 in a reformed fuel supply pathway 142 between the electrochemical cell 150 and the internal combustion engine 130. The use of a reformed fuel storage tank may be desirable because the electrochemical cell 150 may not produce reformed hydrocarbon fuel at the exact same rate it is required by the internal combustion engine 130. For example, the internal combustion engine may require elevated supply rates of reformed hydrocarbon fuel when under significant load or on startup. The reformed fuel storage tank may provide a buffer, capable of supplying the reformed hydrocarbon fuel to the internal combustion engine at the required rates.

The unreacted gas outlet 148 may be structurally configured to direct the unreacted oxidizing gasses to an uncontained atmosphere surrounding the vehicle. The unreacted gas outlet 148 may, in some circumstances, direct at least a portion of unreacted oxidizing gasses to the inlet of the internal combustion engine 130. By directing the at least a portion of unreacted oxidizing gasses to the inlet of the internal combustion engine 130, the unreacted gas outlet 148 may function similar to an exhaust gas recycle in preventing the formation of NOx compounds.

The vehicle 100 may further include an electric motor 160 that is configured to provide motive force to the vehicle. The positive electrode 154 of the electrochemical cell and the negative electrode 156 of the electrochemical cell, may electrically connected to the electric motor 160. The electric motor 160 may provide motive force to the vehicle 100. by applying torque to the internal combustion engine 130 or by applying torque to a transmission or wheel component. For example, the electric motor 160 may be mounted in line with the internal combustion engine 130 and a transmission, or the electric motor 160 may be mounted in line with a wheel hub.

A method of upgrading a hydrocarbon fuel and operating a power producing electrochemical cell 150 may comprise passing the hydrocarbon fuel through the operator accessible point-of-sale fuel filling port 120 into the on-board point-of-sale fuel tank 110, passing the hydrocarbon fuel from the on-board point-of-sale fuel tank 110 to the electrolyte 152 of the electrochemical cell 150, passing the oxidizing gas to the electrochemical cell 150 through the oxidizing gas inlet 146. Some embodiments of the present method may further comprise passing a carbon dioxide gas through the carbon dioxide inlet 143 and contacting the carbon dioxide containing gas with the electrolyte 152.

The method may comprise upgrading the native octane rating of the hydrocarbon fuel in the electrochemical cell 150 and generating the upgraded hydrocarbon fuel, generating electrical energy in the electrochemical cell 150, passing the upgraded hydrocarbon fuel from the electrochemical cell 150 to the combustion zone of the internal combustion engine 130, combusting the upgraded hydrocarbon fuel in the internal combustion engine 130, and utilizing the energy generated in the internal combustion engine to move the vehicle 100. The method may further include generating superoxide at the positive electrode 154, passing the superoxide into the electrolyte 152, and contacting the superoxide with the hydrocarbon fuel.

When the electrochemical cell 150 is operated in a galvanic mode, the generated electric power may be used to satisfy all or part of the vehicle's 100 electric power requirements. The generated electric power may also be used to power an electric motor 160, the electric motor 160 being configured to provide motive force to the vehicle 100. It is believed that an advantage of the above described hybrid setup is to allow the onboard upgrading of low octane fuels, reduce the load on the internal combustion engine 130 by supplying power through an electric motor 106, and thereby improve one or more of emissions, performance, or gas mileage.

It is also noted that recitations herein of “at least one” component, element, etc., should not be used to create an inference that the alternative use of the articles “a” or “an” should be limited to a single component, element, etc.

It is noted that recitations herein of a component of the present disclosure being “configured” in a particular way, to embody a particular property, or to function in a particular manner, are structural recitations, as opposed to recitations of intended use. More specifically, the references herein to the manner in which a component is “configured” denotes an existing physical condition of the component and, as such, is to be taken as a definite recitation of the structural characteristics of the component.

Having described the subject matter of the present disclosure in detail and by reference to specific embodiments thereof, it is noted that the various details disclosed herein should not be taken to imply that these details relate to elements that are essential components of the various embodiments described herein, even in cases where a particular element is illustrated in each of the drawings that accompany the present description. Further, it will be apparent that modifications and variations are possible without departing from the scope of the present disclosure, including, but not limited to, embodiments defined in the appended claims. More specifically, although some aspects of the present disclosure are identified herein as preferred or particularly advantageous, it is contemplated that the present disclosure is not necessarily limited to these aspects.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1. A vehicle comprising
an on-board point-of-sale fuel tank,
an operator accessible point-of-sale fuel filling port that is structurally configured to transfer hydrocarbon fuel from a point-of-sale fuel dispenser to the on-board point-of-sale fuel tank,
an internal combustion engine that is configured to provide motive force to the vehicle,
a reformed fuel sub-system that is structurally configured to reform hydrocarbon fuel from the on-board point-of sale fuel tank and transfer reformed fuel to the internal combustion engine along a reformed fuel supply pathway, wherein:
the reformed fuel subsystem comprises
an electrochemical cell capable of producing electrical energy, and comprising a positive electrode, a negative electrode, and an electrolyte disposed between the positive electrode and the negative electrode,
a hydrocarbon fuel inlet configured to direct at least a portion of hydrocarbon fuel originating from the on-board point-of sale fuel tank to the electrolyte of the electrochemical cell,
an oxidizing gas inlet configured to direct an oxidizing gas to the positive electrode of the electrochemical cell,
an unreacted gas outlet configured to direct at least a portion of an unreacted gas from the electrochemical cell towards the atmosphere, and
a reformed hydrocarbon fuel outlet configured to direct reformed hydrocarbon fuel towards the internal combustion engine;
the positive electrode is configured to form a reduced mediator species from the oxidizing gas;
the electrochemical cell is structurally configured to contact the reduced mediator species and hydrocarbon fuel from the hydrocarbon fuel inlet to upgrade a native octane rating of the hydrocarbon fuel; and
the reformed fuel subsystem is structurally configured to deliver the upgraded hydrocarbon fuel to a combustion zone of the internal combustion engine.

2. The vehicle of claim 1, wherein the negative electrode is selected such that when paired with oxygen, the Gibbs Free Energy of reaction will be negative and the negative electrode will be the anode.

3. The vehicle of claim 1 further comprising an electric motor that is configured to provide motive force to the vehicle; wherein the positive electrode of the electrochemical cell and the negative electrode of the electrochemical cell, are electrically connected to the electric motor.

4. The vehicle of claim 1, wherein:
the reformed fuel subsystem further comprises a carbon dioxide inlet; and
the carbon dioxide inlet is structurally configured to introduce a gas comprising carbon dioxide into the electrolyte.

5. The vehicle of claim 4, wherein hydrocarbon liquids from the hydrocarbon fuel inlet form a heterogeneous liquid hydrocarbon water impermeable barrier layer atop the electrolyte to protect the electrolyte from the intrusion of water or water vapor.

6. The vehicle of claim 1, wherein the carbon dioxide inlet comprises a device for removing water, water vapor, or both.

7. The vehicle of claim 1, wherein the composition of the electrolyte is selected to complex with carbon dioxide from the carbon dioxide inlet and store carbon dioxide as a carbon dioxide-electrolyte complex, oxalate, ester, formate, or carbonate.

8. The vehicle of claim 1, wherein the negative electrode comprises a metal material and the positive electrode comprises a porous material.

9. The vehicle of claim 8, wherein the metal material of the negative electrode comprises lithium, sodium, potassium, magnesium, aluminum, zinc, calcium, copper, silicon, iron, or a combination thereof.

10. The vehicle of claim 1, wherein:
the oxidizing gas inlet is structured to direct the oxidizing gas to the positive electrode, and
the positive electrode is structured to pass at least a portion of the oxidizing gas to the electrolyte disposed between the positive electrode and the negative electrode.

11. The vehicle of claim 1, wherein:
the oxidizing gas inlet is structured to direct the oxidizing gas to the positive electrode,
the positive electrode is structured to convert at least a portion of the oxidizing gas to the reduced mediator species, and
the positive electrode is structured to pass at least a portion of the reduced mediator species to the electrolyte disposed between the positive electrode and the negative electrode.

12. The vehicle of claim 1, wherein the electrolyte comprises an ionic liquid.

13. The vehicle of claim 12, wherein the ionic liquid comprises an imidazolium.

14. The vehicle of claim 12, wherein the ionic liquid comprises AlCl₃ and 1-ethyl-3-methylimidazolium chloride.

15. The vehicle of claim 1, wherein the electrolyte comprises a solvent and a salt, homogeneous catalyst, ionic liquids, suspended heterogeneous catalysts, or a combination thereof.

16. The vehicle of claim 1, wherein the electrochemical cell comprises a separator material disposed between the positive electrode and the negative electrode.

17. The vehicle of claim 1, wherein the electrochemical cell is structurally configured to elevate a concentration of one or more of, aromatic, oxygenated, or carboxylic acid groups in the hydrocarbon fuel.

18. The vehicle of claim 1, wherein the reformed fuel subsystem further comprises a separation unit structurally configured to separate the upgraded hydrocarbon fuel from the electrolyte.

19. The vehicle of claim 1, wherein the reformed fuel subsystem further comprises a distillation unit structurally configured to separate the upgraded hydrocarbon fuel from the electrolyte.

20. The vehicle of claim 1 wherein the electrochemical cell is configured to upgrade one or more liquid hydrocarbon fuels.

21. The vehicle of claim 1, wherein the reformed fuel subsystem comprises a reformed fuel storage tank in a reformed fuel flow path between the electrochemical cell and the internal combustion engine.

22. A vehicle comprising
an on-board point-of-sale fuel tank,
an operator accessible point-of-sale fuel filling port that is structurally configured to transfer hydrocarbon fuel from a point-of-sale fuel dispenser to the on-board point-of-sale fuel tank,
an internal combustion engine that is configured to provide motive force to the vehicle,
an electric motor that is configured to provide motive force to the vehicle,
a reformed fuel sub-system that is structurally configured to reform hydrocarbon fuel from the on-board point-of sale fuel tank and transfer reformed fuel to the internal combustion engine along a reformed fuel supply pathway, wherein:
the reformed fuel subsystem comprises
an electrochemical cell capable of producing electrical energy, and comprising a positive electrode, a negative electrode, and an electrolyte disposed between the positive electrode and the negative electrode,
the negative electrode comprises a metal material,
the electrolyte comprises an ionic liquid,
the negative electrode is selected such that when paired with oxygen, the Gibbs Free Energy of reaction will be negative and the negative electrode will be the anode,
a hydrocarbon fuel inlet configured to direct at least a portion of hydrocarbon fuel originating from the on-board point-of sale fuel tank to the electrolyte of the electrochemical cell,
an oxidizing gas inlet configured to direct an oxidizing gas to the positive electrode of the electrochemical cell,
an unreacted gas outlet configured to direct at least a portion of an unreacted gas from the electrochemical cell towards the atmosphere,
a carbon dioxide inlet structurally configured to introduce a gas comprising carbon dioxide into the electrolyte, and
a reformed hydrocarbon fuel outlet configured to direct reformed hydrocarbon fuel towards the internal combustion engine;
the positive electrode of the electrochemical cell is configured to form a reduced mediator species from the oxidizing gas;
the electrochemical cell is structurally configured to contact the reduced mediator species and hydrocarbon fuel from the hydrocarbon fuel inlet to upgrade a native octane rating of the hydrocarbon fuel;
the positive electrode of the electrochemical cell and the negative electrode of the electrochemical cell are electrically connected to the electric motor; and
the reformed fuel subsystem is structurally configured to deliver the upgraded hydrocarbon fuel to a combustion zone of the internal combustion engine.

23. A method of upgrading a hydrocarbon fuel and operating a power producing electrochemical cell comprising
an on-board point-of-sale fuel tank,
an operator accessible point-of-sale fuel filling port that is structurally configured to transfer hydrocarbon fuel from a point-of-sale fuel dispenser to the on-board point-of-sale fuel tank,
an internal combustion engine that is configured to provide motive force to the vehicle,
a reformed fuel sub-system that is structurally configured to reform hydrocarbon fuel from the on-board point-of sale fuel tank and transfer reformed fuel to the internal combustion engine along a reformed fuel supply pathway, wherein:
the reformed fuel subsystem comprises
an electrochemical cell capable of producing electrical energy, and comprising a positive electrode, a negative electrode, and an electrolyte disposed between the positive electrode and the negative electrode,
a hydrocarbon fuel inlet configured to direct at least a portion of hydrocarbon fuel originating from the on-board point-of sale fuel tank to the electrolyte of the electrochemical cell,
an oxidizing gas inlet configured to direct an oxidizing gas to the positive electrode of the electrochemical cell,
an unreacted gas outlet configured to direct at least a portion of an unreacted gas from the electrochemical cell towards the atmosphere, and
a reformed hydrocarbon fuel outlet configured to direct reformed hydrocarbon fuel towards the internal combustion engine;
the positive electrode of the electrochemical cell is configured to form a reduced mediator species from the oxidizing gas;
the electrochemical cell is structurally configured to contact the reduced mediator species and hydrocarbon fuel from the hydrocarbon fuel inlet with the electrolyte of the electrochemical cell to upgrade a native octane rating of the hydrocarbon fuel; and
the reformed fuel subsystem is structurally configured to deliver the upgraded hydrocarbon fuel to a combustion zone of the internal combustion engine, the method comprising:
passing the hydrocarbon fuel through the point of sale fuel filling port into the on-board point-of-sale fuel tank,
passing the hydrocarbon fuel from the on-board point-of-sale fuel tank to the electrolyte of the electrochemical cell,
passing the oxidizing gas to the electrochemical cell through the oxidizing gas inlet,
upgrading the native octane rating of the hydrocarbon fuel in the electrochemical cell and generating the upgraded hydrocarbon fuel,
generating electrical energy in the electrochemical cell,
passing the upgraded hydrocarbon fuel from the electrochemical cell to the combustion zone of the internal combustion engine,
combusting the upgraded hydrocarbon fuel in the internal combustion engine, and
utilizing the energy generated in the internal combustion engine to move the vehicle.
